(19) United States
(12) Patent Application Publication
(10) Pub. No.: US 2026/0022928 A1
(43) Pub. Date: Jan. 22, 2026

(54) SURFACE HEIGHT DISTRIBUTION MEASURING DEVICE

(71) Applicant: KOBELCO RESEARCH INSTITUTE, INC., Kobe-shi (JP)

(72) Inventors: Kazuyoshi SENOO, Kobe-shi (JP); Yuji YAMAMOTO, Kobe-shi (JP)

(73) Assignee: KOBELCO RESEARCH INSTITUTE, INC., Kobe-shi (JP)

(21) Appl. No.: 19/265,239

(22) Filed: Jul. 10, 2025

(30) Foreign Application Priority Data
Jul. 17, 2024 (JP) 2024-113804

(51) Int. Cl. G01B 7/06

(52) U.S. Cl. CPC G01B 7/082

(57) ABSTRACT

The present invention is a surface height distribution measuring device that measures a surface height distribution in a plate-shaped measurement object. The surface height distribution measuring device includes a non-contact distance measuring unit that measure a distance to a surface of the measurement object in a non-contact manner, a support moving unit that relatively moves the measurement object and the non-contact distance measuring units, and a plate-shaped member provided at a position where, during measurement, the plate-shaped member is in non-contact with the measurement object and is approximately parallel to the measurement object and at least partially covers the measurement object when viewed from a direction perpendicular to the surface of the measurement object.

### FIELD OF INVENTION

The present invention relates to a surface height distribution measuring device that measures a surface height distribution in a plate-shaped measurement object.

### BACKGROUND ART

A measuring device that measures a surface height of a plate-shaped measurement object is disclosed in, for example, Japanese Patent Application Laid-Open No. 2003-75147 (Literature D1). A flatness measuring device disclosed in Literature D1 includes three support sections that support a disk-shaped measurement object at three points, a pair of capacitive displacement sensors that respectively measures distances from the upper and lower positions of the measurement object to the upper and lower surfaces of the measurement object, a lifting and rotating device and a calculator. The lifting and rotating device lifts the measurement object, rotates the measurement object by a predetermined angle, and lowers the measurement object. The support sections support the measurement object. The pair of capacitive displacement sensors scans a straight line passing through the center of the measurement object, and measures the measurement object. The calculator obtains a thickness of the measurement object based on a measurement value of the upper surface and a measurement value of the lower surface. The measurement object is returned to the lifting and rotating device. The lifting and rotating device lifts, rotates, and lowers the measurement object. In such a way, a next straight line is scanned and measured.

In the flatness measuring device disclosed in Literature D1, when the measurement object slightly vibrates in the vertical direction, an error occurs in the distances to the upper and lower surfaces of the measurement object because the measurement is performed by the pair of capacitive displacement sensors. Thus, measurement accuracy deteriorates.

### SUMMARY OF THE INVENTION

The present invention has been made in view of the above circumstance, and an object of the present invention is to provide a surface height distribution measuring device that can accurately perform measurement.

A surface height distribution measuring device according to one aspect of the present invention is a device that measures a surface height distribution in a measurement object having a plate shape, the device including a non-contact distance measuring unit that measure a distance to a surface of the measurement object in a non-contact manner, a support moving unit that relatively moves the measurement object and the non-contact distance measuring unit, and a plate-shaped member provided at a position where, during measurement, the plate-shaped member is in non-contact with the measurement object and is approximately parallel to the measurement object and at least partially covers the measurement object when viewed from a direction perpendicular to the surface of the measurement object.

The above and other objects, features, and advantages of the present invention will be apparent from the following detailed description and accompanying drawings.

### BRIEF DESCRIPTION OF THE DRAWINGS

FIGS. 1A to 1C are diagrams for explaining a structural configuration of a surface height distribution measuring device according to an embodiment;

FIG. 2 is a block diagram illustrating an electrical configuration of the surface height distribution measuring device;

FIG. 3 is a flowchart showing an operation of the surface height distribution measuring device; and

FIG. 4 is a view for explaining an operation of the surface height distribution measuring device.

### DETAILED DESCRIPTION

Hereinafter, one or a plurality of embodiments of the present invention will be described with reference to the drawings. However, the scope of the invention is not limited to the disclosed embodiments. Note that in the drawings, the same reference signs denote the same components, and description thereof will be appropriately omitted. In the present specification, when components are collectively referred to, the components will be denoted by reference signs with suffixes omitted, and when components are individually referred to, the components will be denoted by reference signs with suffixes.

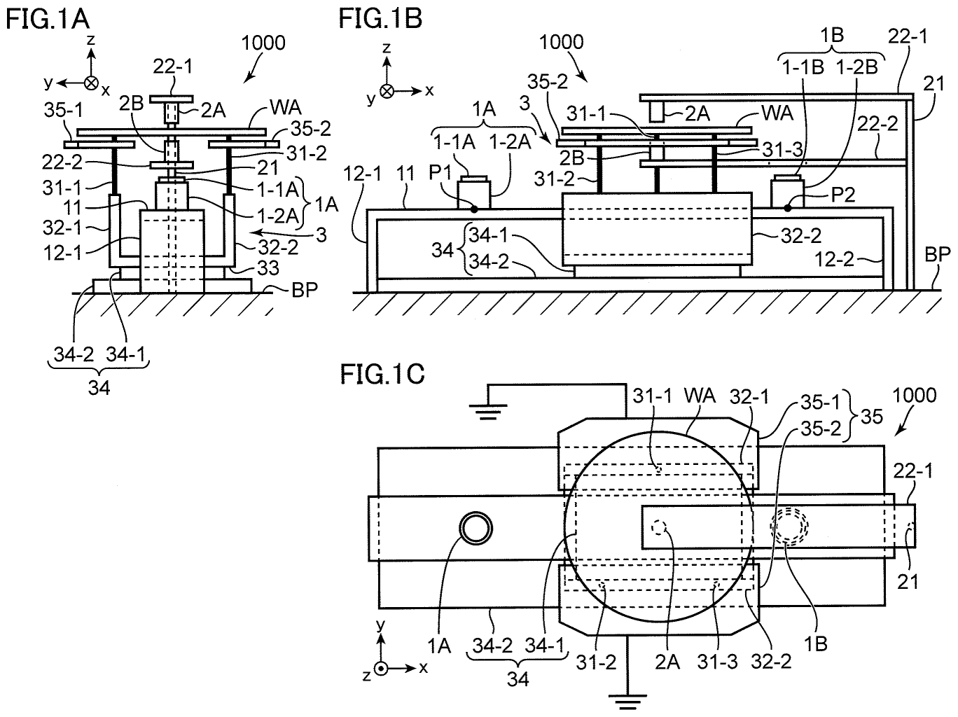

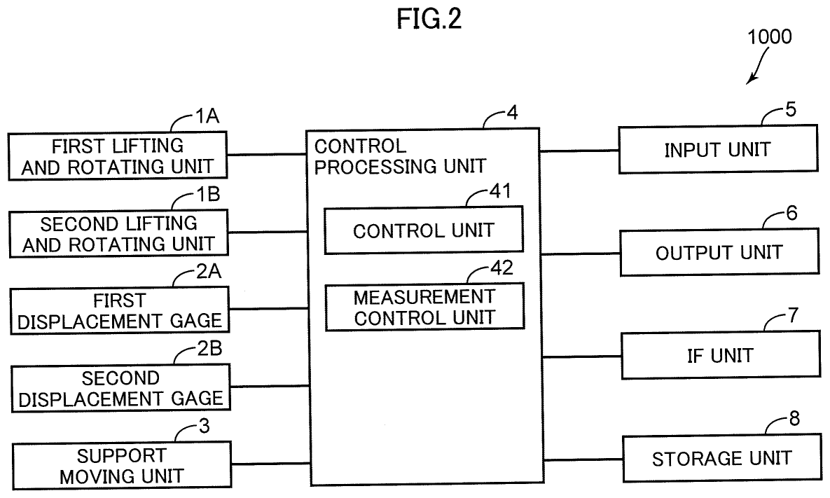

FIGS. 1A to 1C are diagrams for explaining a structural configuration of a surface height distribution measuring device according to the embodiment. FIG. 1A is a front view, FIG. 1B is a side view, and FIG. 1C is a top view. FIG. 2 is a block diagram illustrating an electrical configuration of the surface height distribution measuring device.

As illustrated in FIGS. 1A to 1C and 2, for example, a surface height distribution measuring device 1000 according to the embodiment includes first and second lifting and rotating units 1A and 1B, first and second non-contact distance measuring units 2A and 2B, a support moving unit 3, a control processing unit 4, an input unit 5, an output unit 6, an interface unit (IF unit) 7, and a storage unit 8.

The first and second lifting and rotating units 1A and 1B are devices that are electrically connected to the control processing unit 4, lift and lower a plate-shaped or, in the present embodiment, disc-shaped measurement object WA, and rotate the measurement object WA by a predetermined angle in a circumferential direction under control of the control processing unit 4. The first lifting and rotating unit 1A is disposed at a predetermined first position P1, and the second lifting and rotating unit 1B is disposed at a predetermined second position P2 different from the first position P1. Since the first lifting and rotating unit 1A and the second lifting and rotating unit 1B have the same structure, hereinafter, the first lifting and rotating unit 1A will be mainly described. The reference signs in the configuration of the second lifting and rotating unit 1B will be described in parentheses after the reference signs in the configuration of the first lifting and rotating unit 1A corresponding to the configuration of the second lifting and rotating unit 1B. Thus, the description of the second lifting and rotating unit 1B will be omitted.

More specifically, the first lifting and rotating unit 1A (1B) includes a rotating unit 1-1A (1-1B) and a lifting unit 1-2 A (1-2B). The rotating unit 1-1A (1-1B) includes a rotating member and a rotating mechanism that is electrically connected to the control processing unit 4 and rotates the rotating member in the circumferential direction under the control of the control processing unit 4. The rotating mechanism rotates the rotating member in the circumferential direction to rotate the measurement object WA placed on the upper surface of the rotating member in the circumferential direction. The rotating mechanism includes, for example, a stepping motor and a transfer mechanism that is connected to an output shaft of the stepping motor, has an outer peripheral surface connected to an inner peripheral surface of a rotating member, and transfers a rotational force of the stepping motor to the rotating member. The lifting unit 1-2A (1-2B) includes a guide member that guides the rotating unit 1-1A (1-1B), and a lifting mechanism that is electrically connected to the control processing unit 4, includes, for example, an electromagnetic cylinder and so on, and lifts and lowers the rotating unit 1-1A (1-1B) under control of the control processing unit 4. The lifting mechanism lifts and lowers the measurement object WA placed on the upper surface of the rotating member by lifting and lowering the rotating unit 1-1A (1-1B).

The first lifting and rotating unit 1A is disposed at a predetermined first position P1, and the second lifting and rotating unit 1B is disposed at a predetermined second position P2. The first and second positions are on the upper surface of the first support section 11 which is a plate-shaped member extending in one direction. The first support section 11 is fixed with their both ends being connected to be fixed to, for example, a pair of first and second leg sections 12-1 and 12-2 which are plate-shaped members installed upright on a surface plate BP. Therefore, the first leg section 12-1, first support section 11, and second leg section 12-2 are sequentially connected in this order, and have an approximately downward U shape in a side view as illustrated in FIG. 1B.

For convenience of the description, as illustrated in FIGS. 1A to 1C, an xyz orthogonal coordinate system is set and appropriately used. In this system, the one direction as the extending direction of the first support section 11 is an x axis (an x direction, a front-rear direction), a width direction of the first support section 11 orthogonal to the extending direction is a y axis (a y direction, a right-left direction), and a direction orthogonal to the x direction and the y direction is a z axes (a z direction, a height direction).

The first position P1 is a position where the measurement object WA can be lifted and lowered and can be rotated at the center of the measurement object WA after the scanning of the measurement object WA along a straight line passing through the center of the measurement object WA is completed by the first and second non-contact distance measuring units 2A and 2B on the return path from the second position P2 to the first position P1. For example, the first position P1 is a position separated from the disposing positions of the first and second non-contact distance measuring units 2A and 2B by a diameter of the measurement object WA on one side in the x direction with respect to the disposing positions of the first and second non-contact distance measuring units 2A and 2B. Similarly, the second position P2 is a position where the measurement object WA can be lifted and lowered and can be rotated at the center of the measurement object WA after the scanning of the measurement object WA along the straight line passing through the center of the measurement object WA is completed by the first and second non-contact distance measuring units 2A and 2B on the forward path from the first position P1 to the second position P2. For example, the second position P2 is a position separated from the disposing positions of the first and second non-contact distance measuring units 2A and 2B by the diameter of the measurement object WA on the other side in the x direction with respect to the disposing positions of the first and second non-contact distance measuring units 2A and 2B.

The measurement object WA may be any member as long as it has a plate shape. In the present embodiment, the measurement object WA, which has a disc shape, is, for example, a wafer (for example, a silicon wafer) used for manufacturing a semiconductor, or a substrate for a magnetic disk made of aluminum or glass used for a hard disk.

The first and second non-contact distance measuring units 2A and 2B are devices that are electrically connected to the control processing unit 4 and measure the distance to the surface of the measurement object WA in a non-contact manner under control of the control processing unit 4. Examples of the units are capacitive displacement gages eddy current displacement gages, laser displacement gages, and confocal displacement gages. In the present embodiment, the capacitive displacement gages are used from the viewpoint of noise reduction. The first non-contact distance measuring unit 2A and the second non-contact distance measuring unit 2B are disposed to face each other with a predetermined space (first space) being left therebetween so that the measurement object WA can pass therethrough. With this disposing, the first non-contact distance measuring unit 2A measures a first distance to one surface of the measurement object WA, and the second non-contact distance measuring unit 2B measures a second distance to the other surface of the measurement object WA. Each of the first and second non-contact distance measuring units 2A and 2B outputs a measurement result to the control processing unit 4.

The first non-contact distance measuring unit 2A is disposed at a portion (place) at one end on the lower surface of the first support arm section 22-1, which is a plate-shaped member extending in one direction (x direction). The second non-contact distance measuring unit 2B is disposed at a portion (place) at one end on the upper surface of the second support arm section 22-2, which is a plate-shaped member extending in one direction (x direction) and having a width in the y direction larger than the outer diameter of the second lifting and rotating unit 1B. Each of the first and second support arm sections 22-1 and 22-2 is connected to and fixed to a second support section 21, which is a columnar member installed upright on the surface plate BP on the outer side in the x direction with respect to the second leg section 12-2 (or the outside in the x direction with respect to the first leg section 12-1) at the end portion of each of the other ends. At this time, the first non-contact distance measuring unit 2A and the second non-contact distance measuring unit 2B face each other with the first space being left therebetween. Therefore, the first and second support arm sections 22-1 and 22-2 are disposed apart from each other in the z direction. The first support arm section 22-1, the second support arm section 22-2, and the second support section 21 have an approximately F shape in a side view as illustrated in FIG. 1B. In the second support arm section 22-2, a through opening is formed at a position corresponding to the disposing position of the second lifting and rotating unit 1B so that the second lifting and rotating unit 1B can appear and disappear from the second support arm section 22-2 in the z direction.

Note that the first non-contact distance measuring unit 2A and the second non-contact distance measuring unit 2B may have a structure where the measuring units are held by other units so as to pass through the center of the measurement object WA.

The support moving unit 3 is a device, which is electrically connected to the control processing unit 4, supports the measurement object WA under control of the control processing unit 4, and relatively moves the measurement object WA and the first and second non-contact distance measuring units 2A and 2B between the first and second positions P1 and P2 so that the first and second non-contact distance measuring units 2A and 2B pass through the center of the measurement object WA. In the present embodiment, as described above, the first and second non-contact distance measuring units 2A and 2B are disposed in a fixed manner by the first and second support arm sections 22-1 and 22-2 and the second support section 21. The support moving unit 3 that supports the measurement object WA moves with respect to the first and second non-contact distance measuring units 2A and 2B so that the measurement object WA moves. Note that the surface height distribution measuring device 1000 may be configured so that the first and second non-contact distance measuring units 2A and 2B move with respect to the measurement object WA disposed in a fixed manner.

More specifically, the support moving unit 3 includes three first to third support pins 31-1 to 31-3, a pair of third and fourth support sections 32-1 and 32-2, a connecting section 33, a moving unit 34, and a plate-shaped member 35. Each of the first to third support pins 31-1 to 31-3 is a needle-shaped member or a thin columnar member, and supports the lower surface of the measurement object WA at each end which is one end in the z direction (three-point support). In the present embodiment, each of the first to third support pins 31-1 to 31-3 is made of an insulating material such as resin. The first support pin 31-1 is installed upright at a base end, which is the other end in the z direction, on one end surface of a third support section 32-1 in the z direction. The third support section 32-1 is a plate-shaped member. The second support pin 31-2 is installed upright at a base end, which is the other end in the z direction, on one end surface of a fourth support section 32-2 in the z direction. The fourth support section 32-2 is a plate-shaped member. Similarly, the third support pin 31-3 is installed upright at a base end, which is the other end in the z direction, on one end surface of the fourth support section 32-2 in the z direction. The fourth support section 32-2 is a plate-shaped member. The second support pin 31-2 and the third support pin 31-3 are disposed with a predetermined space (second space) being left therebetween in the x direction. The connecting section 33 is a plate-shaped member having a larger width than the first support section 11 in the y direction. The connecting section 33 is connected and fixed at both ends in the y direction to the other end surfaces of the third and fourth support sections 32-1 and 32-2 in the z direction, respectively, so that the third and fourth support sections 32-1 and 32-2 are installed upright. The third support section 32-1 and the fourth support section 32-2 are disposed outside the first support section 11 with a predetermined space (third space) being left in the y direction. The third support section 32-1, the connecting section 33, and the fourth support section 32-2 are sequentially connected in this order and have an approximately upward U shape in a front view as illustrated in FIG. 1A. The first support section 11 is disposed inside the U shape formed by the third support section 32-1, the connecting section 33, and the fourth support section 32-2. The first to third support pins 31-1 to 31-3 are disposed on the third and fourth support sections 32-1 and 32-2 so as to be positioned at apexes of a triangle. The moving unit 34 is electrically connected to the control processing unit 4. The moving unit 34 is a device that moves the third and fourth support sections 32-1 and 32-2 and the first to third support pins 31-1 to 31-3 supported by the connecting section 33 so that the center of the measurement object WA supported by the first to third support pins 31-1 to 31-3 can move at least between the first position P1 and the second position P2 along the x direction under control of the control processing unit 4. The moving unit 34 includes, for example, a housing 34-1 as a box body and a pedestal 34-2 extending in the x direction from the inside of the first leg section 12-1 to the inside of the second leg section 12-2. The pedestal 34-2 includes a rack extending in the x direction. An upper surface of the housing 34-1 is connected and fixed to the connecting section 33, and contains a pinion for linearly moving on the rack and an actuator, such as a servomotor, for rotating the pinion. The moving unit 34 is configured to cause the rack and pinion to linearly move the housing 34-1 and the connecting section 33 with respect to the pedestal 34-2. The movement of the connecting section 33 moves the measurement object WA supported by the first to third support pins 31-1 to 31-3 along the x direction.

The number of the support pins 31 may be more than 3. Further, the shape of the support pins 31 may be a shape different from that of the needle-shaped member or the thin columnar member.

The first and second lifting and rotating units 1A and 1B are placed on a first member including the first leg section 12-1, the first support section 11, and the second leg section 12-2. The first and second non-contact distance measuring units 2A and 2B are placed on a second member including the first support arm section 22-1, the second support arm section 22-2, and the second support section 21. The first member and the second member are disposed so that the center of the first lifting and rotating unit 1A (the first position P1), the centers of the first and second non-contact distance measuring units 2A and 2B, and the center of the second lifting and rotating unit 1B (the second position P2) are aligned in this order along the x direction. The moving unit 34 is disposed for the first leg section 12-1, the first support section 11, the second leg section 12-2, the first support arm section 22-1, the second support arm section 22-2, and the second support section 21 that are disposed as described above. In this disposing, in a case where the measurement object WA is placed on the first lifting and rotating unit 1A (or the second lifting and rotating unit 1B) and is supported by the first to third support pins 31-1 to 31-3 with the center of the first lifting and rotating unit 1A (or the center of the second lifting and rotating unit 1B) being aligned with the center of the measurement object WA, the center of the measurement object WA supported by the first to third support pins 31-1 to 31-3 moves on a straight line passing through the center (the first position P1) of the first lifting and rotating unit 1A and the center (the second position P2) of the second lifting and rotating unit 1B.

The plate-shaped member 35 is a member provided at a position where the member is in non-contact with the measurement object WA and is approximately parallel to the measurement object WA at a time when the first and second non-contact distance measuring units 2A and 2B perform measurement, and at least partially covers the measurement object WA when viewed from a direction (in the present embodiment, the z direction) perpendicular to the surface of the measurement object WA. In the present embodiment, since the measurement object WA is moved by the moving unit 34, the plate-shaped member 35 includes first and second plate-shaped members 35-1 and 35-2 disposed with a predetermined space (fourth space) slightly wider than the width (length in the y direction) of the first lifting and rotating unit 1A and the second lifting and rotating unit 1B being left.

The first plate-shaped member 35-1 has, for example, a rectangular shape, and is installed and fixed to the first support pin 31-1 so that, when the measurement object WA is disposed at the leading ends of the first to third support pins 31-1 to 31-3, the rear face of the measurement object WA and the surface of the first plate-shaped member 35-1 are parallel, and the leading end portion of the first support pin 31-1 protrudes to the outside of the first plate-shaped member 35-1. Therefore, the first plate-shaped member 35-1 and the measurement object WA are separated from each other in the z direction with a space (fifth space) with a length corresponding to the leading end of the first support pin 31-1 being left. Further, in the present embodiment, the first plate-shaped member 35-1 is attached to the first support pin 31-1 so that the side on the first support section 11 side extending in the one direction (x direction) is parallel to the side of the first support section 11 and the first plate-shaped member 35-1 is disposed outside the first lifting and rotating unit 1A and the second lifting and rotating unit 1B in the width direction (y direction) of the first support section 11. When the measurement object WA is placed at the leading ends of the first to third support pins 31-1 to 31-3, the first plate-shaped member 35-1 has an area that covers at least a portion of the measurement object WA outside the first support section 11 in the +y direction (first portion of the measurement object WA) when viewed from the z direction. The first plate-shaped member 35-1 is attached to the first support pin 31-1 so as to cover at least the first portion on the rear face of the measurement object WA. Therefore, the first portion of the measurement object WA and the first plate-shaped member 35-1 overlap in the z direction. The first plate-shaped member 35-1 is made of a conductor metal (including an alloy) such as aluminum and is grounded. Alternatively, for example, the first plate-shaped member 35-1 is made of a semiconductor material such as a silicon semiconductor and is grounded. Note that the first support pin 31-1 and the first plate-shaped member 35-1 may be configured to be attached to a member disposed below the first plate-shaped member 35-1.

The second plate-shaped member 35-2 has, for example, a rectangular shape, and is installed to and fixed to the second and third support pins 31-2 and 31-3 so that when the measurement object WA is disposed at the leading ends of the first to third support pins 31-1 to 31-3, the rear face of the measurement object WA and the surface of the second plate-shaped member 35-2 are parallel, and the leading end portions of the second and third support pins 31-2 and 31-3 protrude outward from the second plate-shaped member 35-2 by a length corresponding to the fifth space. Therefore, the second plate-shaped member 35-2 and the measurement object WA are separated from each other in the z direction by the fifth space. Further, in the present embodiment, the second plate-shaped member 35-2 is attached to the second and third support pins 31-2 and 31-3 so that the side on the first support section 11 side extending in the one direction (x direction) is parallel to the side of the first support section 11 and the second plate-shaped member 35-2 is disposed outside the first lifting and rotating unit 1A and the second lifting and rotating unit 1B in the width direction (y direction) of the first support section 11. When the measurement object WA is placed at the leading ends of the first to third support pins 31-1 to 31-3, the second plate-shaped member 35-2 has an area that covers at least a portion of the measurement object WA outside the first support section 11 in the −y direction (second portion of the measurement object WA) when viewed from the z direction. The second plate-shaped member 35-2 is attached to the second and third support pins 31-2 and 31-3 so as to cover the second portion on the rear face of the measurement object WA. Therefore, the second portion of the measurement object WA and the second plate-shaped member 35-2 overlap in the z direction. The second plate-shaped member 35-2 is made of conductor metal (including an alloy) such as aluminum and is grounded. Alternatively, for example, the second plate-shaped member 35-2 is made of a semiconductor material such as a silicon semiconductor and is grounded. Note that the second and third support pins 31-2 and 31-3 and the second plate-shaped member 35-2 may be configured to be attached to a member disposed below the second plate-shaped member 35-2.

The first and second plate-shaped members 35-1 and 35-2 preferably cover the measurement object WA as widely as possible within a range where appearance and disappearance of the first and second lifting and rotating units 1A and 1B is not inhibited and the measurement of the second non-contact distance measuring unit 2B is not inhibited.

The fifth apace has a length by which the measurement object WA does not come in contact with the first and second plate-shaped members 35-1 and 35-2 due to deflection of the measurement object WA under its own weight, individual variations (product variations), or the like, and is preferably shorter (smaller). The fifth space is, for example, several mm or less such as 0.5 mm, 1 mm, or 2 mm.

Each of the first and second plate-shaped members 35-1 and 35-2 is not limited to the rectangular shape, and may have another shape such as a semicircular shape. Further, the plate-shaped member 35 may be, for example, one member having a square shape or a circular shape in which a through opening is formed in a central portion. The through opening allows the first and second lifting and rotating units 1A and 1B to appear and disappear in the z direction in a case where the first non-contact distance measuring unit 2A measures only the surface height distribution of the measurement object WA from a predetermined reference surface and the second non-contact distance measuring unit 2B does not perform measurement.

The input unit 5 is a device that is electrically connected to the control processing unit 4 and inputs, to the surface height distribution measuring device 1000, various commands such as a command for instructing the start of measurement, and various types of data, such as a name and a predetermined angle of the measurement object WA, necessary for causing the surface height distribution measuring device 1000 to operate. Examples of the input unit 5 are a plurality of input switches to which predetermined functions are assigned, a keyboard, and a mouse. The output unit 6 is a device that is electrically connected to the control processing unit 4 and outputs commands, data, and calculation results input from the input unit 5 under control of the control processing unit 4. Examples of the output unit 6 are a display device, such as a cathode ray tube (CRT) display, a liquid crystal display (LCD), or an organic electroluminescence (EL) display, and a printing device such as a printer.

Note that the input unit 5 and the output unit 6 may be constituted by a touch panel. When the touch panel is constituted, the input unit 5 is a position input device that detects and inputs operations of a resistance film system or a capacitive system, for example. The output unit 6 is a display device. In this touch panel, the position input device is provided on a display surface of the display device, and one or a plurality of input content candidates that can be input are displayed on the display device. When a user touches a display position where an input content desired to be input is displayed, the position input device detects the touched position, and the display content displayed at the detected position is input to the surface height distribution measuring device 1000 as a user's operation input content. In such a touch panel, since the user can easily and intuitively understand the input operation, the surface height distribution measuring device 1000 that is easy for the user to handle is provided.

The IF unit 7 is a circuit that is electrically connected to the control processing unit 4 and inputs or outputs data to or from an external device under control of the control processing unit 4. Examples of the IF unit 7 are an interface circuit of RS-232C which is a serial communication system, an interface circuit using the Bluetooth (registered trademark) standard, and an interface circuit using the Universal Serial Bus (USB) standard. Further, the IF unit 7 may be a communication interface circuit, such as a data communication card, or a communication interface circuit according to the Institute of Electrical and Electronics Engineers (IEEE) 802.11 standard, that transmits and receives a communication signal with an external device.

The storage unit 8 is a circuit that is connected to the control processing unit 4 and stores various predetermined programs and various predetermined data under control of the control processing unit 4.

The various predetermined programs include, for example, a control processing program, and the control processing program includes, for example, a control program, and a measurement control program. The control program controls each of the units 1A, 1B, 2A, 2B, 3, and 5 to 8 of the surface height distribution measuring device 1000 in accordance with a function of each unit. The measurement control program is a program for controlling measurement of the measurement object WA.

The various types of predetermined data includes data, such as a name of the measurement object WA, a predetermined angle, predetermined sampling intervals, and measurement results, necessary for executing these programs.

Such the storage unit 8 includes a read only memory (ROM) that is a nonvolatile storage element, and an electrically erasable programmable read only memory (EEPROM) that is a rewritable nonvolatile storage element. The storage unit 8 includes a random access memory (RAM) serving as a so-called working memory of the control processing unit 4, the working memory storing data and the like generated during execution of the predetermined programs. Further, the storage unit 8 may include a hard disk device or a solid state drive (SSD) having a relatively large storage capacity.

The control processing unit 4 is a circuit that causes each of the units 1A, 1B, 2A, 2B, 3, and 5 to 8 of the surface height distribution measuring device 1000 in accordance with the function of each unit to measure the surface height distribution in the measurement object. The control processing unit 4 includes, for example, a central processing unit (CPU) and its peripheral circuits. In the control processing unit 4, a control unit 41 and a measurement control unit 42 are functionally implemented by executing the control processing program.

The control unit 41 controls each of the units 1A, 1B, 2A, 2B, 3, and 5 to 8 of the surface height distribution measuring device 1000 in accordance with the function of each unit, and generally controls the surface height distribution measuring device 1000.

The measurement control unit 42 controls the measurement of the measurement object WA. More specifically, the measurement control unit 42 causes the first lifting and rotating unit 1A to rotate the measurement object WA by a predetermined angle in the circumferential direction. The measurement control unit 42 controls the first lifting and rotating unit 1A and the support moving unit 3 so that the measurement object WA is supported from the first lifting and rotating unit 1A to the support moving unit 3. The measurement control unit 42 controls the support moving unit 3 and the first and second non-contact distance measuring units 2A and 2B so that the first and second non-contact distance measuring units 2A and 2B respectively measure the first distance to the one surface and the second distance to the other surface of the measurement object WA at predetermined sampling intervals while the measurement object WA is being moved from the first position P1 to the second position P2 by the support moving unit 3. The measurement control unit 42 controls the support moving unit 3 and the second lifting and rotating unit 1B so that the measurement object WA is supported from the support moving unit 3 to the second lifting and rotating unit 1B. The measurement control unit 42 causes the second lifting and rotating unit 1B to rotate the measurement object WA by the predetermined angle in the circumferential direction. The measurement control unit 42 controls the second lifting and rotating unit 1B and the support moving unit 3 so that the measurement object WA is supported from the second lifting and rotating unit 1B to the support moving unit 3. The measurement control unit 42 controls the support moving unit 3 and the first and second non-contact distance measuring units 2A and 2B so that the first and second non-contact distance measuring units 2A and 2B respectively measure the first and second distances at the predetermined sampling intervals while the measurement object WA is being moved from the second position P2 to the first position P1 by the support moving unit 3. The measurement control unit 42 controls the support moving unit 3 and the first lifting and rotating unit 1A so that the measurement object WA is supported from the support moving unit 3 to the first lifting and rotating unit 1A.

The thickness of the measurement object WA can be calculated with the following method. The distance between the disposing position of the first non-contact distance measuring unit 2A and the disposing position of the second non-contact distance measuring unit 2B is obtained in advance. This thickness can be obtained based on the distance between the first non-contact distance measuring unit 2A and the surface of the measurement object WA and the distance between the second non-contact distance measuring unit 2B and the rear face of the measurement object WA ((the thickness of the measurement object WA)=(the distance between the disposing position of the first non-contact distance measuring unit 2A and the disposing position of the second non-contact distance measuring unit 2B)−((the first distance to the surface of WA measured by the first non-contact distance measuring unit 2A)+(the second distance to the surface of WA, the second distance being measured by the second non-contact distance measuring unit 2B)). A device form for obtaining the thickness distribution of the measurement object WA by obtaining the thickness of the measurement object WA at each measurement point with such a method is also one form of the surface height distribution measuring device of the present invention.

The control processing unit 4, the input unit 5, the output unit 6, the IF unit 7, and the storage unit 8 in the surface height distribution measuring device 1000 can be configured by, for example, a desktop computer or a notebook computer.

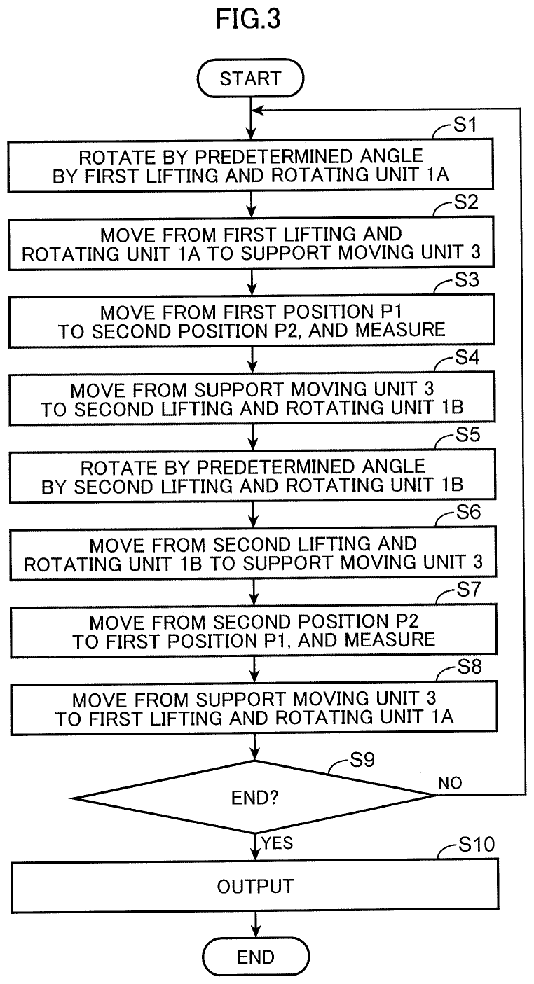

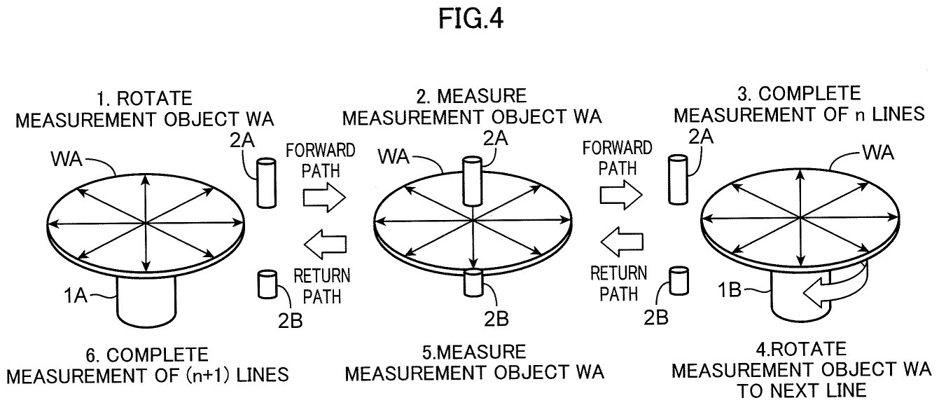

Next, the operation of the present embodiment will be described. FIG. 3 is a flowchart showing the operation of the surface height distribution measuring device. FIG. 4 is a view for explaining the operation of the surface height distribution measuring device.

When the surface height distribution measuring device 1000 having such a configuration is powered on, initialization of necessary units is performed, and the operation is started. In the control processing unit 4, the control unit 41 and the measurement control unit 42 are functionally configured by executing the control processing program.

In FIGS. 2 and 3, for example, when the user, a robot arm (not illustrated), or the like places the measurement object WA on the first lifting and rotating unit 1A with the centers being aligned, and the start of measurement is instructed, the measurement control unit 42 of the control processing unit 4 in the surface height distribution measuring device 1000 controls the first lifting and rotating unit 1A so that the measurement object WA is rotated by a predetermined angle in the circumferential direction (S1, 1. Rotation of measurement object WA).

Subsequently, in the surface height distribution measuring device 1000, the measurement control unit 42 controls the first lifting and rotating unit 1A and the support moving unit 3 so that the measurement object WA is supported from the first lifting and rotating unit 1A to the support moving unit 3 by lifting and lowering (S2).

In the surface height distribution measuring device 1000, the measurement control unit 42 controls the support moving unit 3 and the first and second non-contact distance measuring units 2A and 2B so that the first and second non-contact distance measuring units 2A and 2B respectively measure the first distance to the one surface and the second distance to the other surface of the measurement object WA at predetermined sampling intervals while the measurement object WA is being moved from the first position P1 to the second position P2 by the support moving unit 3 (S3, 2. Measurement of measurement object WA). The surface height distribution (the first A surface height distribution (the height of each measurement point at the predetermined sampling intervals)) on one surface of the measurement object WA and the surface height distribution (the first B surface height distribution (the height of each measurement point at the predetermined sampling intervals)) on the other surface of the measurement object WA are stored in the storage unit 8 in association with the order of the measurement n. The surface height distribution on the one surface of the measurement object WA is the measurement result in the first non-contact distance measuring unit 2A. The surface height distribution on the other surface of the measurement object WA is the measurement result in the second non-contact distance measuring unit 2B. Alternatively, the order of the measurement n may be a cumulative rotation angle starting from the initial position (=(one rotation angle)×(the number measurement times n)).

Subsequently, in the surface height distribution measuring device 1000, the measurement control unit 42 controls the support moving unit 3 and the second lifting and rotating unit 1B so that the measurement object WA is supported from the support moving unit 3 to the second lifting and rotating unit 1B by lifting and lowering (S4, 3. Completion of measurement of n lines).

In the surface height distribution measuring device 1000, the measurement control unit 42 causes the second lifting and rotating unit 1B to rotate the measurement object WA by the predetermined angle in the circumferential direction (S5, 4. Rotation of measurement object WA to next line).

In the surface height distribution measuring device 1000, the measurement control unit 42 controls the second lifting and rotating unit 1B and the support moving unit 3 so that the measurement object WA is supported from the second lifting and rotating unit 1B to the support moving unit 3 by lifting and lowering (S6).

In the surface height distribution measuring device 1000, the measurement control unit 42 controls the support moving unit 3 and the first and second non-contact distance measuring units 2A and 2B so that the first and second non-contact distance measuring units 2A and 2B respectively measure the first and second distances at the predetermined sampling intervals while the measurement object WA is being moved from the second position P2 to the first position P1 by the support moving unit 3 (S7, 5. Measurement of measurement object WA). The surface height distribution (the second A surface height distribution) on one surface of the measurement object WA and the surface height distribution (the second B surface height distribution) on the other surface of the measurement object WA are stored in the storage unit 8 in association with the order of the measurement n. The surface height distribution on the one surface of the measurement object WA is the measurement result in the first non-contact distance measuring unit 2A. The surface height distribution on the other surface of the measurement object WA is the measurement result in the second non-contact distance measuring unit 2B. Alternatively, the order of the measurement n may be a cumulative rotation angle starting from the initial position.

Subsequently, in the surface height distribution measuring device 1000, the measurement control unit 42 controls the support moving unit 3 and the first lifting and rotating unit 1A so that the measurement object WA is supported from the support moving unit 3 to the first lifting and rotating unit 1A by lifting and lowering (S8, 6. Completion of measurement of (n+1) lines).

In the surface height distribution measuring device 1000, the measurement control unit 42 determines whether the measurement is ended (S9). As a result of the determination, in a case where the measurement is ended (Yes), the surface height distribution measuring device 1000 outputs each measurement result to the output unit 6 (S10), and ends the processing. On the other hand, as a result of the determination, in a case where the measurement is not ended (No), the surface height distribution measuring device 1000 returns the processing to the processing S1. The determination of the end of the measurement is made, for example, based on whether the measurement has been performed a required number of measurement times or more, the required number being obtained by dividing 360 [degrees] by one rotation angle (in a case where the required number of measurement times is an even number, the end of the measurement is determined at the time when the measurement is performed at the required number of measurement times, and in a case where the required number of measurement times is an odd number, the end of the measurement is determined at the time when the measurement of (the required number of measurement times+1) is performed).

Note that the measurement control unit 42 may output each measurement result to an external device via the IF unit 7 as necessary. In the first measurement immediately after the start of the measurement, the processing S1 may be omitted.

As described above, since the surface height distribution measuring device 1000 in the embodiment includes the plate-shaped member 35, vibration can be reduced by an air layer between the measurement object WA and the plate-shaped member 35, and thus the measurement can be performed with higher accuracy.

In the surface height distribution measuring device 1000, a capacitor is formed by the measurement object and the plate-shaped member. In a case where the first and second non-contact distance measuring units 2A and 2B are capacitive displacement gages, an alternating electric field is generated in the measurement. Therefore, the capacitor enables the surface height distribution measuring device 1000 to reduce noise in the measurement with the capacitive displacement gages.

Since the surface height distribution measuring device 1000 measures the surface height distribution in each of the forward path from the first position P1 to the second position P2 and the return path from the second position P2 to the first position P1, the measurement time can be shortened as compared with the case of measuring only in one of the forward path and the return path.

Since the surface height distribution measuring device 1000 includes the first and second non-contact distance measuring units 2A and 2B facing each other via the measurement object WA, the surface height distribution of each of one surface and the other surface of the measurement object WA can be simultaneously measured.

The present specification discloses various aspects of techniques as described above, and the main techniques of the disclosed aspects are summarized below.

The surface height distribution measuring device according to one aspect is a device that measures a surface height distribution in a measurement object having a plate shape, the device including a non-contact distance measuring unit that measures a distance to a surface of the measurement object in a non-contact manner, a moving unit that relatively moves the measurement object and the non-contact distance measuring unit, and a plate-shaped member provided at a position where, during measurement by the non-contact distance measuring unit, the plate-shaped member is in non-contact with the measurement object and is approximately parallel to the measurement object, and at least partially covers the measurement object when viewed from a direction perpendicular to the surface of the measurement object.

Since the surface height distribution measuring device includes the plate-shaped member, vibration can be reduced by the air layer between the measurement object and the plate-shaped member, and thus the measurement can be performed with higher accuracy.

According to another aspect, in the above-described surface height distribution measuring device, the measurement object is either a conductor or a semiconductor, the non-contact distance measuring unit is a capacitive displacement gage, and the plate-shaped member is either a conductor or a semiconductor that is grounded.

In the surface height distribution measuring device, the capacitor is formed by the measurement object and the plate-shaped member. In a case where the non-contact distance measuring unit are capacitive displacement gages, an alternating electric field is generated in the measurement. Therefore, the capacitor enables the surface height distribution measuring device to reduce noise in the measurement with the capacitive displacement gages.

According to still another aspect, in the above-described surface height distribution measuring device, the measurement object has a disk shape, and the surface height distribution measuring device further includes a first rotating unit disposed at a first position, the first rotating unit rotating the measurement object by a predetermined angle in a circumferential direction, and a second rotating unit disposed at a second position different from the first position, the second rotating unit rotating the measurement object by the predetermined angle in the circumferential direction, and the moving unit relatively moves the measurement object and the non-contact distance measuring unit between the first position and the second position.

Since the surface height distribution measuring device measures the surface height distribution in each of the forward path from the first position to the second position and the return path from the second position to the first position, the measurement time can be shortened as compared with the case of measuring only in one of the forward path and the return path.

This application is based on Japanese Patent Application No. 2024-113804 filed on Jul. 17, 2024, the content of which is included in the present application.

Although the present invention has been appropriately and sufficiently described through the embodiments with reference to the above drawings to express the present invention, it should be recognized that a person skilled in the art can easily modify and/or improve the above-described embodiments. Therefore, unless a change or improvement made by a person skilled in the art is at a level departing from the scope of rights of the claims described in claims, the change or improvement is interpreted to be included in the scope of rights of the claims.

The present invention can provide the surface height distribution measuring device that measures a surface height distribution in a plate-shaped measurement object.

1. A surface height distribution measuring device that measures a surface height distribution in a measurement object having a plate shape, the surface height distribution measuring device comprising:
a non-contact distance measuring unit that measures a distance to a surface of the measurement object in a non-contact manner;
a moving unit that relatively moves the measurement object and the non-contact distance measuring unit; and
a plate-shaped member provided at a position where, during measurement by the non-contact distance measuring unit, the plate-shaped member is in non-contact with the measurement object and is approximately parallel to the measurement object, and at least partially covers the measurement object when viewed from a direction perpendicular to the surface of the measurement object.

2. The surface height distribution measuring device according to claim 1, wherein
the measurement object is either a conductor or a semiconductor,
the non-contact distance measuring unit is a capacitive displacement gage, and
the plate-shaped member is either a conductor or a semiconductor that is grounded.

3. The surface height distribution measuring device according to claim 1, wherein
the measurement object has a disk shape, and
the surface height distribution measuring device further comprises:
a first rotating unit disposed at a first position, the first rotating unit rotating the measurement object by a predetermined angle in a circumferential direction; and
a second rotating unit disposed at a second position different from the first position, the second rotating unit rotating the measurement object by the predetermined angle in the circumferential direction, and
the moving unit relatively moves the measurement object and the non-contact distance measuring unit between the first position and the second position.
